(19) United States
(12) Patent Application Publication
(10) Pub. No.: US 2022/0337168 A1
(43) Pub. Date: Oct. 20, 2022

(54) POWER SUPPLY CONVERTER

(71) Applicant: Silergy Semiconductor Technology (Hangzhou) LTD, Hangzhou (CN)

(72) Inventors: Huiqiang Chen, Hangzhou (CN); Jianxin Wang, Hangzhou (CN)

(21) Appl. No.: 17/723,756

(22) Filed: Apr. 19, 2022

(30) Foreign Application Priority Data
Apr. 19, 2021 (CN) 202110420715.2

(51) Int. Cl. H02M 7/06; H02M 3/07

(52) U.S. Cl. CPC H02M 7/06; H02M 3/07

(57) ABSTRACT

A power supply converter can include: an AC-DC linear circuit configured to rectify an AC input voltage to generate a DC voltage, and to transfer the input energy to an output terminal thereof during at least part of a time interval when the DC voltage is greater than an output voltage thereof, in order to generate a first output voltage and a first output current; and a conversion circuit configured to convert the first output voltage to a second output voltage, and to convert the first output current to a second output current for a load.

### RELATED APPLICATIONS

This application claims the benefit of Chinese Patent Application No. 202110420715.2, filed on Apr. 19, 2021, which is incorporated herein by reference in its entirety.

### FIELD OF THE INVENTION

The present invention generally relates to the field of power electronics, and more particularly to power supply converters.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of an example power supply converter.

FIG. 2 is a waveform diagram of one example operation of the first example power supply converter.

FIG. 3 is a schematic block diagram of an example control circuit of the first example power supply converter.

FIG. 4 is a waveform diagram of another example operation of the first example power supply converter.

FIG. 5 is a schematic block diagram of a first example power supply converter, in accordance with embodiments of the present invention.

FIG. 6 is a schematic block diagram of a second example power supply converter, in accordance with embodiments of the present invention.

FIG. 7 is a waveform diagram of one example operation of the power supply converter, in accordance with embodiments of the present invention.

FIG. 8 is a waveform diagram of another example operation of the power supply converter, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

A power supply converter can convert unregulated power from an AC or DC power supply to a regulated output voltage, and load current for a load. For modern electronics, such as smart phones, mobile phones, tablets/notebooks/portables, digital cameras, digital video cameras, handheld game consoles, or wearable devices (e.g., glasses, twist rings, watches, bracelets, headphones, headsets, headphones, etc.), etc., the power supply converter is essential.

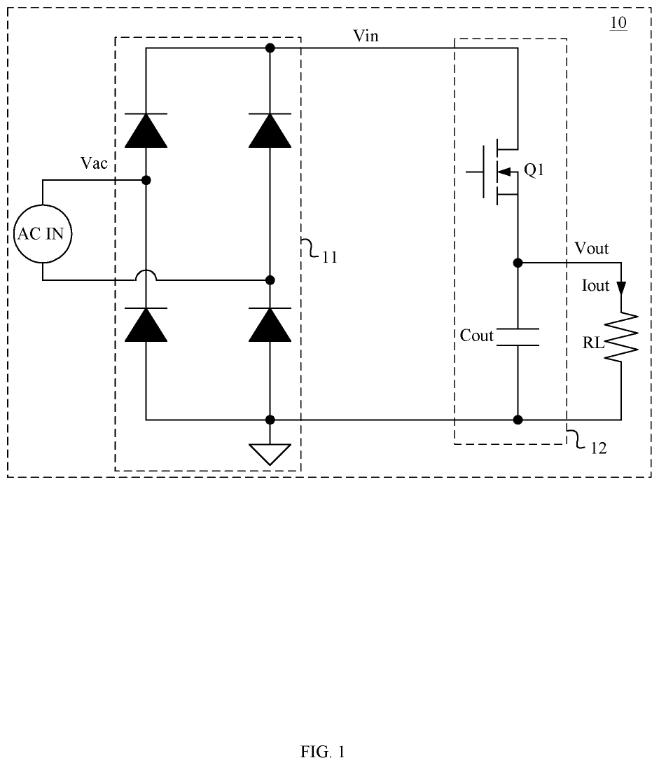

Referring now to FIG. 1, shown is a schematic block diagram of an example power supply converter. In this particular example, power supply converter 10 of the comparative example can include rectifier circuit 11 and linear step-down circuit 12. Rectifier circuit 11 can rectify AC input voltage Vac and then output DC voltage Vin. Linear step-down circuit 12 can connect in parallel between the positive and negative output terminals of rectifier circuit 11, and may receive DC voltage Vin, and transfer the input energy to an output terminal thereof when DC voltage Vin is greater than output voltage Vout, in order to generate output voltage Vout.

In this example, linear step-down circuit 12 can include transistor Q1 and energy storage capacitor Cout connected in series. A first power terminal (e.g., the drain) of transistor Q1 can connect to the positive output terminal of rectifier circuit 11, and a second power terminal (e.g., the source) of transistor Q1 can connect to the first terminal of energy storage capacitor Cout. The second terminal of energy storage capacitor Cout can connect to the reference ground, where output voltage Vout of the power supply converter can be provided at the first terminal of energy storage capacitor Cout.

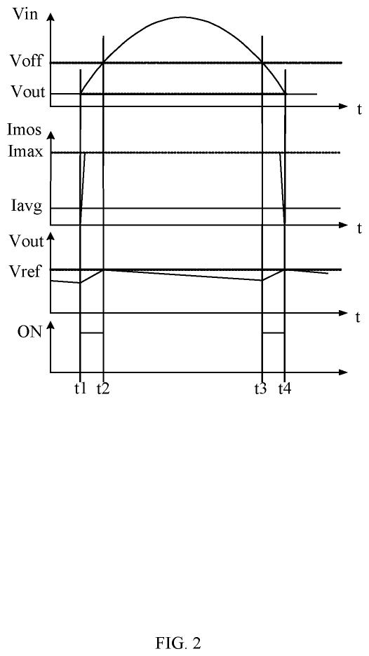

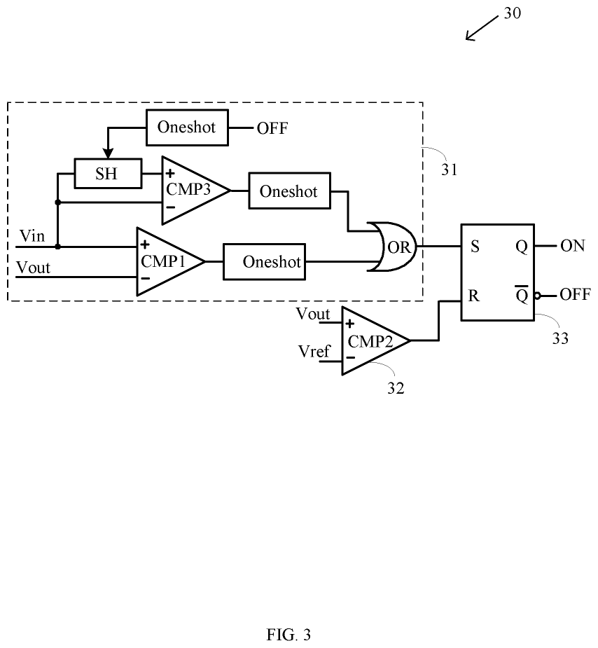

Referring now to FIG. 2, shown is a waveform diagram of one example operation of the first example power supply converter. Referring also to FIG. 3, shown is a schematic block diagram of an example control circuit of the first example power supply converter. The operation process of power supply converter 10 will be described with reference to FIGS. 2 and 3. Here, control circuit 30 shown in FIG. 3 will be described first.

In this example, control circuit 30 can include set control circuit 31, reset control circuit 32, and logic circuit 33. Set control circuit 31 can generate at least one valid set control signal Vs when DC voltage Vin reaches output voltage Vout. A non-inverting input terminal of comparator CMP1 can receive DC voltage Vin, and the inverting input terminal of comparator CMP1 may receive output voltage Vout. Comparator CMP1 can generate a comparison signal at an output terminal. When DC voltage Vin rises to output voltage Vout, after the comparison signal passes through corresponding single-pulse flip-flop ‘oneshot’, a single-pulse signal can be generated and configured as set control signal Vs. Reset control circuit 32 can generate an effective reset control signal Vr when output voltage Vout reaches reference voltage Vref representing the desired output voltage. The non-inverting input terminal of comparator CMP2 may receive output voltage Vout, and the inverting input terminal of comparator CMP2 can receive reference voltage Vref. When output voltage Vout rises to reference voltage Vref, the comparison signal output by comparator CMP2 can be activated. The comparison signal can be used as reset control signal Vr. Further, set control signal Vs and reset control signal Vr can respectively control the turn-on moment and turn-off moment of transistor Q1 in one switching cycle. Logic circuit 33 can generate turn-on control signal ON and turn-off control signal OFF based on set control signal Vs and reset control signal Vr to control transistor Q1 to be turned on and off, respectively.

In this example, transistor Q1 can be turned on twice in half the power frequency cycle. Initially, after DC voltage Vin rises to output voltage Vout, transistor Q1 is turned on once, and secondly, before DC voltage Vin drops to output voltage Vout, transistor Q1 may also be turned on once, such that the input energy is transferred to the output terminal of power supply converter 10 when the DC voltage Vin is greater than output voltage Vout. Therefore, set control circuit 31 of control circuit 30 can also include comparator CMP3, the inverting input terminal of the comparator CMP3 may receive DC voltage Vin, and the non-inverting input terminal of comparator CMP3 may receive DC voltage Vin sampled and held at the moment of turning off transistor Q1. When DC voltage Vin drops to the value of DC voltage Vin sampled and held at the moment of turning off transistor Q1, the comparison signal output by comparator CMP3 can be activated, and corresponding single-pulse flip-flop ‘oneshot’ may generate a single-pulse signal as set control signal Vs after receiving the comparison signal.

In this example, the transistor can operate in an off state and an on state. In the off state, the transistor may exhibit an extremely high resistance such that the current flowing through thereof is almost zero. In the on state, the transistor may operate in a linear state, and in this linear state, the current flowing through the transistor can be controlled according to the voltage at the control terminal (e.g., the gate of the transistor); that is, the transistor can linearly conduct. In addition, the linear state does not refer to a fully on state where the transistor exhibits an extremely low resistance, and the voltage drop across the transistor is nearly zero. It should also be noted that, only a schematic block diagram of a control circuit for realizing the control of the turn-on moment and turn-off moment of the transistor is given. The control circuit can control the transistor to operate in the linear state, and the current flowing through the transistor can be controlled to near a predetermined value. The control circuit may adopt any suitable implementation in certain embodiments. The operating process of power converter 10 can be described with reference to FIGS. 2 and 3.

At time t1, when DC voltage Vin rises to output voltage Vout, the comparison signal output by comparator CMP1 can be at an active level, then control signal Vs can be activated to make transistor Q1 turn on, and transistor Q1 can be turned on at this stage. Turn-on control signal ON can be maintained at a high level, transistor Q1 can be controlled to be linearly turned on to output a constant predetermined current Imax, and predetermined current Imax can charge energy storage capacitor Cout, such that output voltage Vout tends to rise. At time t2, when output voltage Vout of the power supply converter rises to reference voltage Vref representing the desired output voltage, the comparison signal output by comparator CMP2 can be at an active level, reset control signal Vr can be at an active level to turn off transistor Q1, and DC voltage Vin can be sampled and hold at the moment of turning off transistor Q1.

At time t3, DC voltage Vin drops to the value of DC voltage Vin sampled and held at the moment of turning off transistor Q1, and the comparison signal output by comparator CMP3 can be at an active level, such that transistor Q1 is turned on again within half the power frequency cycle. During this stage, turn-on control signal ON can be maintained at a high level, transistor Q1 can be controlled to be linearly turned on and may output a constant predetermined current Imax. The predetermined current Imax can charge output capacitor Cout such that output voltage Vout has a rising trend. At time t4, DC voltage Vin may drop below output voltage Vout, the comparison signal output by comparator CMP2 can be at an active level, and reset control signal Vr can be at an active level to turn off transistor Q1.

Therefore, power supply converter 10 in the comparative example can transfer the input energy to the output terminal when the input voltage (e.g., DC input voltage Vin) is greater than output voltage Vout, such that output voltage Vout is maintained at reference voltage Vref. Also, during transistor Q1 being linearly turned on, output average current Iavg can be maintained at the desired value by adjusting the value of the predetermined current Imax. In this control mode, the system can obtain higher efficiency than other approaches. However, the system efficiency of the power converter of the comparative example may still need further improvement.

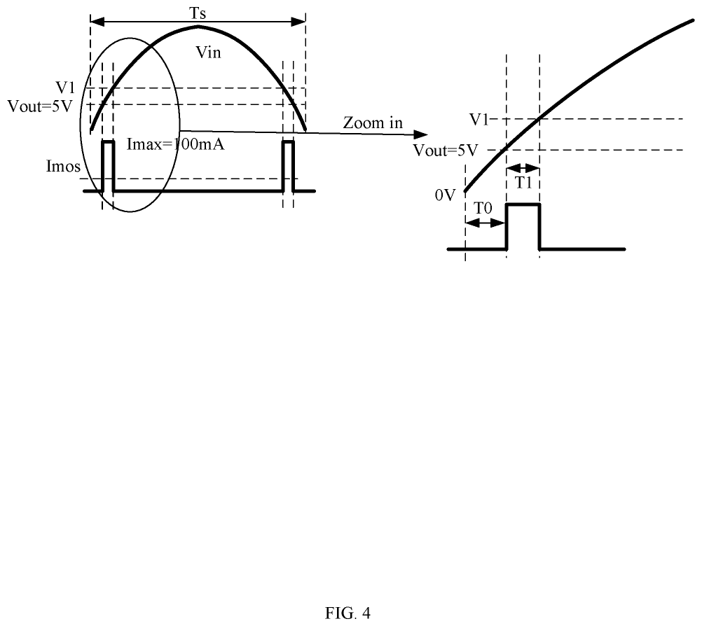

Referring now to FIG. 4, shown is a waveform diagram of another example operation of the first example power supply converter. The efficiency of the power supply converter in the comparative example is analyzed below with reference to FIG. 4 and a specific operating parameter condition. For example, in a power supply converter, alternating current input voltage Vac is 230V, the operating frequency of alternating current input voltage Vac is 50 Hz, output voltage Vout of the power supply converter is 5V, output average current Iavg is 10 mA, and predetermined current Imax output by transistor Q1 in the linear conduction stage is 100 mA. According to formula (1), the conduction time of transistor Q1 can be calculated as shown.

2*T1*100 mA=10 mA*Ts (1)

Here, Ts is the power frequency cycle, and T1 is 0.5 ms. Time T0 can be calculated according to formula (2) below.

√2*Vin*sin(2π*T0)=5V (2)

Here, T0 is 51.1 us, then the value of voltage V1 of DC voltage Vin corresponding to the first turn-off moment of transistor Q1 can be calculated according to formula (3) below.

V1=√2*Vin*sin(2pi*(T0+T1))=53.61V (3)

Therefore, average efficiency η of the power converter can be calculated; that is, the ratio of output voltage Vout to average value Vin_avg of DC voltage Vin corresponding to the input current of linear step-down circuit 12 can be calculated according to formula (4) below.

η≈Vout/Vin_avg=5V/((53.61−5)/2+5)=17.06% (4)

From this, it can be seen that the system efficiency of the power converter of the comparative example is relatively low. In particular embodiments, a power supply converter is applied to an AC/DC power supply, and can include an AC-DC linear circuit and a conversion circuit. The AC/DC linear circuit can rectify an AC input voltage and generate a DC voltage, and transmit the input energy to the output terminal thereof in at least a part of the time interval when the DC voltage is greater than an output voltage of the AC-DC linear circuit, in order to generate a first output voltage. The conversion circuit can convert a first output voltage to generate a second output voltage for the load. Particular embodiments aim to improve the ratio of the first output voltage to the average value of the DC voltage corresponding to the input current of the linear step-down circuit in the AC-DC linear circuit by adjusting the voltage conversion ratio of the power supply converter, in order to improve the system efficiency.

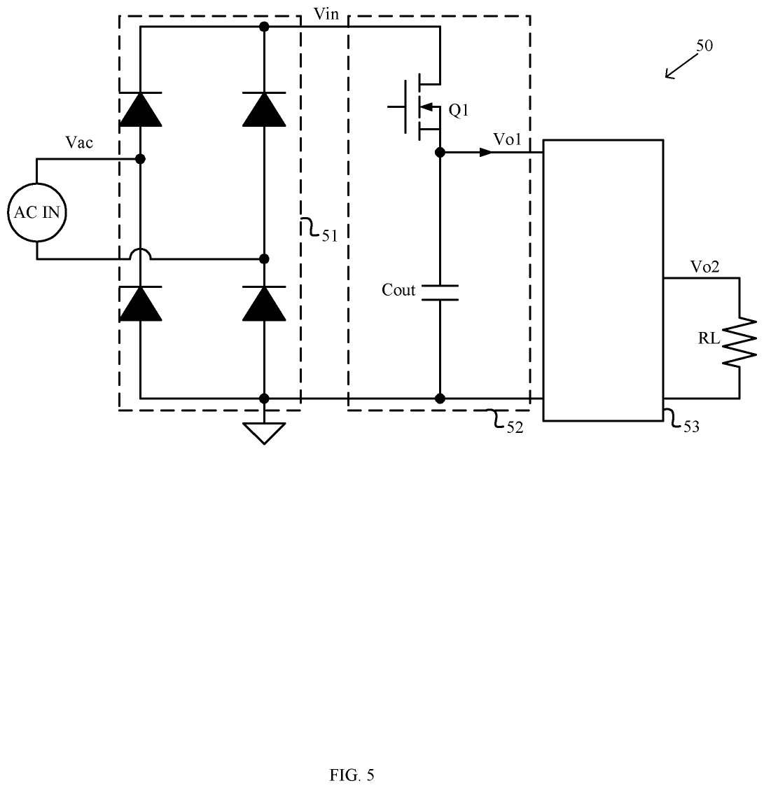

Referring now to FIG. 5, shown is a schematic block diagram of a first example power supply converter, in accordance with embodiments of the present invention. In this particular example, the AC-DC linear circuit in power supply converter 50 can include rectifier circuit 51 and linear step-down circuit 52. The AC-DC linear circuit can rectify AC input voltage Vac and generate DC voltage Vin, and can transfer the input energy to the output terminal thereof during at least part of the time interval when DC voltage Vin is greater than the output voltage of the AC-DC linear circuit, in order to generate first output voltage Vo.

In one embodiment, rectifier circuit 51 can rectify AC input voltage Vac to generate DC voltage Vin. Linear step-down circuit 52 can connect in parallel between the positive output terminal and the negative output terminal of rectifier circuit 51, may receive DC voltage Vin, and can charge energy storage capacitor Cout by a constant current during at least part of the time interval when DC voltage Vin is greater than the output voltage of linear step-down circuit 52. Thus, output voltage Vo1 across energy storage capacitor Cout can be generated.

In this embodiment, linear step-down circuit 52 can include transistor Q1 and energy storage capacitor Cout connected in series. Transistor Q1 can be linearly turned on at least once when DC voltage Vin is greater than output voltage Vo1, in order to generate the constant current. The constant current can charge energy storage capacitor Cout, in order to control output voltage Vo1 to rise to reference voltage Vref. For example, the first power terminal of transistor Q1 can connect to the positive output terminal of rectifier circuit 51, the second power terminal of transistor Q1 can connect to the first terminal of energy storage capacitor Cout, and the second terminal of energy storage capacitor Cout can connect to the reference ground; that is, the negative output terminal of rectifier circuit 51. Output voltage Vo1 may be generated at the first terminal of energy storage capacitor Cout.

In particular embodiments, rectifier circuit 51 may adopt an integrated rectifier bridge or a rectifier composed of a plurality of discrete devices, etc., and may be used to perform synchronous rectification on the connected alternating current input voltage. It should be understood that the “ground” mentioned herein does not necessarily mean being connected to the actual ground (the ground zero potential), but can instead mean being connected to the low potential reference terminal of the circuit. For example, if the negative terminal of the power supply converter is used as the low potential reference terminal, the “ground” may refer to the negative terminal of the power supply converter.

In one embodiment, transistor Q1 in linear step-down circuit 52 can be controlled in the same way as in the comparative example. Further, after DC voltage Vin rises to output voltage Vo1, transistor Q1 can be turned on once, and before DC voltage Vin drops to output voltage Vo1. That is, when DC voltage Vin drops to the value of DC voltage Vin corresponding to the moment of turning off transistor Q1, transistor Q1 can be linearly turned on again, such that the input energy is transferred to the output terminal of the AC-DC linear circuit during at least part of the time interval when DC voltage Vin is greater than output voltage Vo1. In addition, transistor Q1 can be turned off every time when output voltage Vo1 rises to reference voltage Vref.

In addition, power supply converter 50 in certain embodiments can include conversion circuit 53. The voltage conversion ratio of conversion circuit 53 is the ratio of output voltage Vo1 to output voltage Vo2, and can control the ratio of output voltage Vo1 to average value Vin_avg of DC voltage Vin corresponding to the input current of linear step-down circuit 52 to approach a maximum value. Here, DC voltage Vin corresponding to the input current of linear step-down circuit 52 may refer to DC voltage Vin during the period when transistor Q1 is linearly turned on to generate the constant current.

It should be noted that, in example power supply converter 50, conversion circuit 53 can be cascaded after the AC-DC linear circuit, so after the output voltage required by power supply 50, that is, output voltage Vo2, is determined, the voltage conversion ratio of voltage supply converter 50 can be adjusted, in order to set output voltage Vo1 to an appropriate value. The appropriate value can ensure that the ratio of output voltage Vo1 to average value Vin_avg of DC voltage Vin corresponding to the input current of linear step-down circuit 52 in the AC-DC linear circuit is increased, even approaching the maximum value. Further, this ratio can characterize the operating efficiency of the AC-DC linear circuit, and the system efficiency can be improved by improving the operating efficiency of the AC-DC linear circuit.

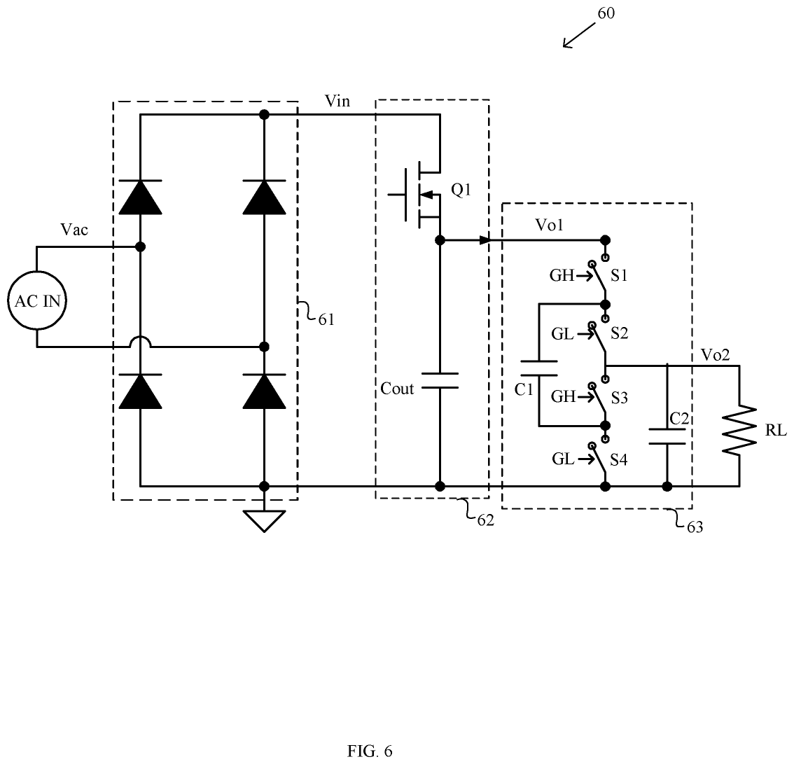

Referring now to FIG. 6, shown is a schematic block diagram of a second example power supply converter, in accordance with embodiments of the present invention. The difference between this power supply converter and power supply converter 50 shown in FIG. 5 is that the circuit structure of conversion circuit 63 is further disclosed. In this example, conversion circuit 63 can be configured as a switched capacitor converter, which may be used for receiving output voltage Vo1 and converting output voltage Vo1 into output voltage Vo2 according to the voltage conversion ratio. Here, the voltage conversion ratio is the ratio of output voltage Vo1 to output voltage Vo2.

For example, the switched capacitor converter can include at least one switched capacitor conversion unit, where each of the switched capacitor conversion units can include two switch groups and a flying capacitor, each switch group can include two switches connected in series, and the flying capacitor can connect between the two switch groups. For example, switches S l-S4 can be sequentially connected in series between the first terminal and the second terminal (e.g., the ground terminal) of the input port of the switched capacitor converter. Switches S1 and S2 may form a first switch group, switches S3 and S4 may form a second switch group, one terminal of flying capacitor C1 can connect to a common node of switches S1 and S2, and the other terminal of flying capacitor C1 can connect to a common node of switches S3 and S4.

In addition, switches S1 and S3 of the switched capacitor converter can be turned on synchronously, switches S2 and S4 may be turned on synchronously, and the two conduction periods may not overlap each other. Further, both switches S1 and S3 can be controlled by switch control signal GH, and switches S2 and S4 may be both controlled by switch control signal GL. In this example, switch control signals GH and GL are taken as complementary signals for illustration; that is, when signal GH is at a high level, signal GL is at a low level, and vice versa. In addition, switches S1-S4 can be N-type MOSFETs. Therefore, when switch control signal GH is at a high level, switches S1 and S3 can be turned on, and a first loop circuit may be formed from the input port via switch S1, flying capacitor C1, switch S3, and capacitor C2. In this way, output voltage Vo1 can charge flying capacitor C1 and capacitor C2.

When switch control signal GL is at a high level, switches S2 and S4 can be turned on, and a second loop circuit may be formed including switch S2, flying capacitor C1, switch S4, and capacitor C2. During this period, the energy storage in flying capacitor C1 and capacitor C2 can supply power to the load and output voltage Vo2s is generated. The voltage on each capacitor can be ½ of the input voltage; that is, ½ of output voltage Vo1. Therefore, by controlling the states of the switch groups to switch continuously, the capacitor can be repeatedly charged and discharged, thereby maintaining a substantially constant output. According to the above analysis, the ratio of the output voltage to the input voltage of the switched capacitor converter is a fixed value, which can be independent of the duty cycle of switch control signal GH or GL.

In this example, the voltage conversion ratio of the switched capacitor converter, that is, the ratio of output voltage Vo1 to output voltage Vo2 is 2 as just one example for illustration. If other voltage conversion ratios, such as 4, are required, this can be realized by cascading the two switched capacitor conversion units in FIG. 6. If the voltage conversion ratio is required to be 8, this can be realized by cascading three switched capacitor conversion units in FIG. 6, and so on. Of course, in other examples, conversion circuit 63 may also be implemented by circuits of other structures, as long as the voltage conversion can be realized.

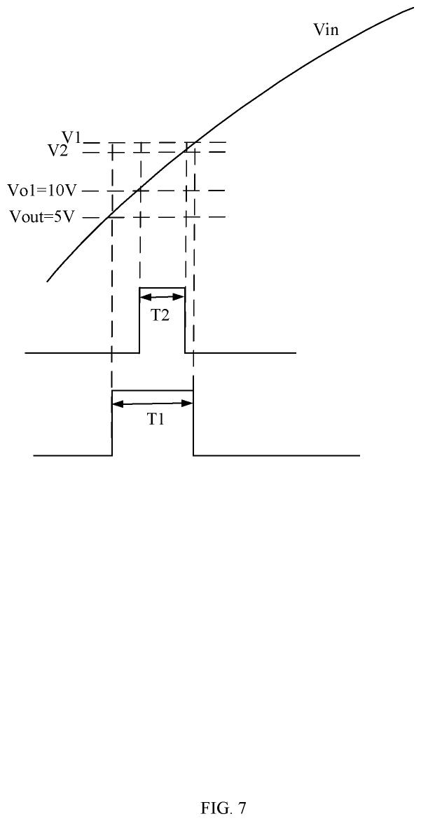

Referring now to FIG. 7, shown is a waveform diagram of one example operation of the power supply converter, in accordance with embodiments of the present invention. The efficiency of power supply converter 60 in certain embodiments is analyzed with reference to FIG. 7 and a specific operating parameter condition. In the power supply converter, alternating current input voltage Vac is 230V, the operating frequency of alternating current input voltage Vac is 50 Hz, output voltage Vo2 of the power supply converter is 5V, output average current Iavg is 10 mA, and predetermined current Imax output by transistor Q1 in the linear conduction stage is 100 mA.

When the voltage conversion ratio of power supply converter 63 is selected to be 2, according to the law of energy conservation, output voltage Vo1 output by the AC-DC linear circuit is 10V, and average output current Iavg of the AC-DC linear circuit is 5 mA, Then, according to the average value of the input current of linear step-down circuit 62 in the AC-DC linear circuit is equal to output average current Iavg, conduction time T2 of transistor Qlcan be calculated according to formula (5) below.

2*T2*100 mA=5 mA*Ts (5)

Here, Ts is the power frequency cycle, and T2 is 0.25 ms. As compared with the first example power supply in FIG. 4, conduction time T2 of the transistor in this example is less than conduction time T1 of the transistor in FIG. 4. Time T0 can be calculated according to formula (6) below.

√2*Vin*sin(2π*T0)=10V (6)

Here, T0 is 102.3 us, then the value of voltage V2 of DC voltage Vin corresponding to the moment of turning off transistor Q1 for the first time can be calculated according to formula (7) below.

V2=√2*Vin*sin(290 *(T0+T2))=34.36V (7)

Therefore, the average efficiency η of the AC-DC linear circuit can be calculated, that is, the ratio of output voltage Vo1 to average value Vin_avg of the DC voltage Vin corresponding to the input current of linear step-down circuit 62, can be calculated according to formula (8) below.

η≈Vo1/Vin_avg=10V/((34.36−10)/2+10)=45.08% (8)

It can be seen that power supply converter 60 in certain embodiments increases the output voltage of the AC-DC linear circuit, that is, output voltage Vo1, by 2 times, that is, 10V, by adding conversion circuit 63 with a voltage converter ratio of 2, and the average input current of linear step-down circuit 62 is linearly reduced to ½ (e.g., 5 mA). When DC voltage Vin and predetermined current Imax of transistor Q1 are both the same, average value Vin_avg of input voltage Vin corresponding to the input current of linear step-down circuit 62 is reduced. Further, due to the increase of output voltage Vo1, the efficiency of power supply converter 60 can be increased by more than 2 times.

In particular embodiments, by cascading a voltage converter after the existing AC-DC linear circuit, the first output voltage output by the AC-DC linear circuit can be increased, and under the condition of the same DC voltage and the same transistor, the average value of the input voltage during the conduction period of the transistor may be reduced, such that the ratio of the first output voltage to the average value of the DC voltage is increased. That is, the efficiency of the power supply converter can be improved.

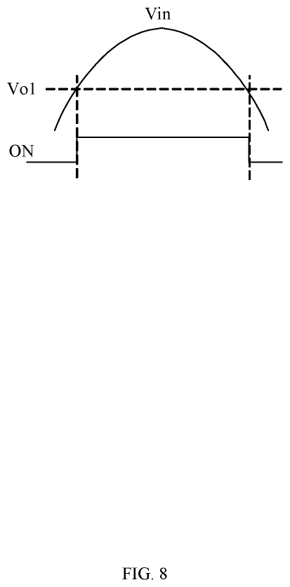

Referring now to FIG. 8, shown is a waveform diagram of another example operation of the power supply converter, in accordance with embodiments of the present invention. This example control method that is different from the control method of transistor Q1 in linear step-down circuit 52 in FIG. 5 can be provided in FIG. 8. Transistor Q1 can be turned on only once in a half power frequency cycle, that is, when DC voltage Vin rises to output voltage Vo1, transistor Q1 can be turned on, and transistor Q1 may be turned off until DC voltage Vin drops to output voltage Vo1. That is, in the half power frequency cycle, when DC voltage Vin is greater than output voltage Vo1, transistors Q1 may all be turned on, such that when DC voltage is greater than the output voltage of the AC-DC linear circuit, the input energy is transferred to the output terminal thereof.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A power supply converter, comprising:
a) an AC-DC linear circuit configured to rectify an AC input voltage to generate a DC voltage, and to transfer the input energy to an output terminal thereof during at least part of a time interval when the DC voltage is greater than an output voltage thereof, in order to generate a first output voltage and a first output current; and
b) a conversion circuit configured to convert the first output voltage to a second output voltage, and to convert the first output current to a second output current for a load.

2. The power supply converter of claim 1, wherein the AC-DC linear circuit comprises:
a) a rectifier circuit configured to rectify the AC input voltage to generate the DC voltage; and
b) a linear step-down circuit coupled in parallel between a positive output terminal and a negative output terminal of the rectifier circuit, and being configured to receive the DC voltage, and to generate a constant current for charging an energy storage capacitor during at least part of the time interval when the DC voltage is greater than the output voltage of linear step-down circuit, wherein the first output voltage is generated across the energy storage capacitor.

3. The power supply converter of claim 2, wherein the linear step-down circuit comprises a transistor and the energy storage capacitor coupled in series, wherein the transistor is turned on at least once during a period when the DC voltage is close to the first output voltage and operates in a linear state to generate the constant current that charges the energy storage capacitor, such that the first output voltage rises to a reference voltage.

4. The power supply converter of claim 2, wherein the linear step-down circuit comprises a transistor and the energy storage capacitor coupled in series, wherein a first power terminal of the transistor is coupled to the positive output terminal of the rectifier circuit, a second power terminal of the transistor is coupled to a first terminal of the energy storage capacitor, a second terminal of the energy storage capacitor is coupled to a reference ground, and the first output voltage is generated at the first terminal of the energy storage capacitor.

5. The power supply converter of claim 2, wherein a voltage conversion ratio of the conversion circuit is a ratio of the first output voltage to the second output voltage, and is configured to improve a ratio of the first output voltage to an average value of the DC voltage corresponding to an input current of the linear step-down circuit.

6. The power supply converter of claim 5, wherein the voltage conversion ratio of the conversion circuit is not less than 1.

7. The power supply converter of claim 3, wherein a voltage conversion ratio of the conversion circuit is a ratio of the first output voltage to the second output voltage, and is configured to improve a ratio of the first output voltage to an average value of the DC voltage during a conduction period of the transistor.

8. The power converter of claim 5, wherein the conversion circuit is configured as a switched capacitor converter that is used for receiving the first output voltage and converting the first output voltage into the second output voltage according to the voltage conversion ratio.

9. The power supply converter of claim 8, wherein the switched capacitor converter comprises at least one switched capacitor conversion unit, each of the switched capacitor conversion units having two switch groups and a flying capacitor, and wherein each switch group comprises two switches coupled in series, and the flying capacitor is coupled between the two switch groups.

10. The power supply converter of claim 3, wherein the transistor is turned on when the DC voltage rises to the first output voltage.

11. The power supply converter of claim 10, wherein the transistor is turned off when the first output voltage rises to the reference voltage, and is turned on again when the DC voltage drops to a value of the DC voltage corresponding to the turn-off moment of the transistor.

12. The power supply converter of claim 3, wherein the transistor is turned on when the DC voltage rises to the first output voltage, and is turned off when the DC voltage drops to the first output voltage.
